(19) United States
(12) Patent Application Publication
(10) Pub. No.: US 2019/0080285 A1
(43) Pub. Date: Mar. 14, 2019

(54) SYSTEMS AND METHODS FOR DYNAMIC DELIVERY

(71) Applicant: Walmart Apollo, LLC, Bentonville, AR (US)

(72) Inventors: Balasubramanian Natarajan, Bentonville, AR (US); Kalaiselvan Muniyan, Bentonville, AR (US); Karunanithi Sivasubramanian, Bentonville, AR (US)

(21) Appl. No.: 16/130,074

(22) Filed: Sep. 13, 2018

Related U.S. Application Data
(60) Provisional application No. 62/558,013, filed on Sep. 13, 2017.

(51) Int. Cl. G06Q 10/08; G06F 17/30; G06F 9/54; H04W 4/021; H04W 4/029; G06Q 20/32; G06Q 30/06

(52) U.S. Cl. CPC G06Q 10/0833; G06F 17/30241; G06F 9/542; G06Q 30/0635; H04W 4/029; G06Q 20/3224; H04W 4/021

(57) ABSTRACT

Systems, methods, and machine readable media are provided for dynamic delivery scheduling. In exemplary embodiments, order data and travel data is received. The travel data includes a travel service identifier related to a travel facility, an expected arrival time at the travel facility, and an identification of a destination facility. An order request is transmitted with the order data to the destination facility. The destination facility includes a geo-fence configured to detect an individual's mobile device, and the order request is processed by the destination facility upon detection of the individual's mobile device via the geo-fence. Following an updated arrival time being identified for the individual at the travel facility, a command may be transmitted to the destination facility to deliver the order to a location in the travel facility when the updated arrival time is forecasted to be outside of an operating hours' time period for the destination facility.

### CROSS-REFERENCE TO RELATED PATENT APPLICATION

This application claims priority to U.S. Provisional Application 62/558,013 filed on Sep. 13, 2017, the content of which is hereby incorporated by reference in its entirety.

### BACKGROUND

A geo-fence is a virtual perimeter for a real-world geographic area. A geo-fence can be dynamically generated or can be a predefined set of boundaries. The use of a geo-fence is called geo-fencing, and one example of usage involves a location-aware device entering or exiting a geo-fence. This activity could trigger an alert to the device's user as well as messaging to the geo-fence operator.

### SUMMARY

In one embodiment, a system for dynamic delivery scheduling is provided. The system includes a mobile application executable on an individual's mobile device, a destination facility with a geo-fence configured to detect the individual's mobile device, and a computing system equipped with a processor and communicatively coupled to the mobile application and the destination facility. The computing device is configured to execute a travel module, an order module and a delivery module. The travel module when executed receives travel data including at least a travel service identifier related to a travel facility, an expected arrival time at the travel facility, and an identification of the destination facility. The order module when executed receives order data including one or more items for delivery, and transmits an order request with the order data to the destination facility to be processed by the destination facility upon detection of the individual's mobile device via the geo-fence. The delivery module when executed identifies an updated arrival time for the individual at the travel facility based on the travel data, and transmits a command to the destination facility to deliver the one or more items to a location in the travel facility when the updated arrival time is forecasted to be outside of an operating hours time period for the destination facility.

In another embodiment, a computer-implemented method for dynamic delivery scheduling is provided. The method includes receiving travel data including at least a travel service identifier related to a travel facility, an expected arrival time at the travel facility, and an identification of a destination facility. The method also includes receiving order data including one or more items for delivery, and transmitting an order request with the order data to the destination facility. The destination facility includes a geo-fence configured to detect an individual's mobile device. The order request is to be processed by the destination facility upon detection of the individual's mobile device via the geo-fence. The method also includes identifying an updated arrival time for the individual at the travel facility based on the travel data, and transmitting a command to the destination facility to deliver the one or more items to a location in the travel facility when the updated arrival time is forecasted to be outside of an operating hours time period for the destination facility.

In another embodiment, a non-transitory machine-readable medium is provided that stores instructions executable by a processing device. Execution of the instructions causes the processing device to implement a method for dynamic delivery scheduling. The method includes receiving travel data including at least a travel service identifier related to a travel facility, an expected arrival time at the travel facility, and an identification of a destination facility. The method also includes receiving order data including one or more items for delivery, and transmitting an order request with the order data to the destination facility. The destination facility includes a geo-fence configured to detect an individual's mobile device. The order request is to be processed by the destination facility upon detection of the individual's mobile device via the geo-fence. The method also includes identifying an updated arrival time for the individual at the travel facility based on the travel data, and transmitting a command to the destination facility to deliver the one or more items to a location in the travel facility when the updated arrival time is forecasted to be outside of an operating hours time period for the destination facility.

### BRIEF DESCRIPTION OF THE DRAWINGS

The accompanying drawings, which are incorporated in and constitute a part of this specification, illustrate one or more embodiments of the invention and, together with the description, help to explain the invention. The embodiments are illustrated by way of example and should not be construed to limit the present disclosure. In the drawings:

FIG. 1 is a block diagram showing a dynamic delivery system in terms of modules, according to an example embodiment;

FIG. 2 is a flowchart illustrating an exemplary method for dynamic delivery scheduling, according to an example embodiment;

FIG. 3 is a block diagram depicting software services provided by the dynamic delivery system, according to an example embodiment;

FIG. 4 is a flowchart illustrating an exemplary method for the dynamic delivery system, according to an example embodiment;

FIG. 5 is a flowchart illustrating an exemplary method for the dynamic delivery system, according to an example embodiment;

FIG. 6 is a flowchart illustrating an exemplary method for the dynamic delivery system, according to an example embodiment;

FIG. 7 is a flowchart illustrating an exemplary method for the dynamic delivery system, according to an example embodiment;

FIG. 8 is a diagram of an exemplary network environment suitable for a distributed implementation of exemplary embodiments; and

FIG. 9 is a block diagram of an exemplary computing device that may be used to implement exemplary embodiments described herein.

### DETAILED DESCRIPTION

Exemplary embodiments provide a dynamic delivery system for scheduling delivery of an order based on dynamically detected changes in an individual's travel plans. In one embodiment, the individual places an order for one or more items that he or she wishes to pick up or have delivered during his or her travels. The individual also provides information for his or her travel plans. The dynamic delivery system described herein analyzes the order data and the travel data to determine an appropriate delivery method or location. The dynamic delivery system is also configured to update the delivery method or location based on detected changes or updates to the travel plans of the individual. In example embodiments, the dynamic delivery system allows the individual to pick up the order at a store, or offers delivery of the order at a travel facility. In other embodiments, the dynamic delivery system enables various options for delivery or pick up of the order, including in-store pick up, curb side pick up, delivery at the travel facility where the individual is scheduled to arrive, or delivery at a hotel where the user is scheduled to stay during his or her travels. The dynamic delivery system may include a mobile application that the individual can download or install on his or her client device to place orders.

Retailers allow customers to buy from a store or online, and either deliver the purchased product to their home or enable the customer to pick up the item at a nearby retail store. However, the dynamic delivery system described herein allows customers additional delivery options. The dynamic delivery system allows customers to synchronize their order with their travel plans.

While traveling, an individual may find it difficult to locate retail stores, since the travel destination may be an unfamiliar place for the individual. Moreover, if an individual purchases items prior to travel and attempts to transport them with him or her, some of items may be perishable and may expire or spoil during transport. The individual may also be limited by federal laws with respect to what items he or she can transport or carry with him or her during travel.

The dynamic delivery system described herein allows individuals to plan for the necessary items during their travel plan. Individuals are also enabled to pre-order the items they want so that they are available at a hotel while they are checking in.

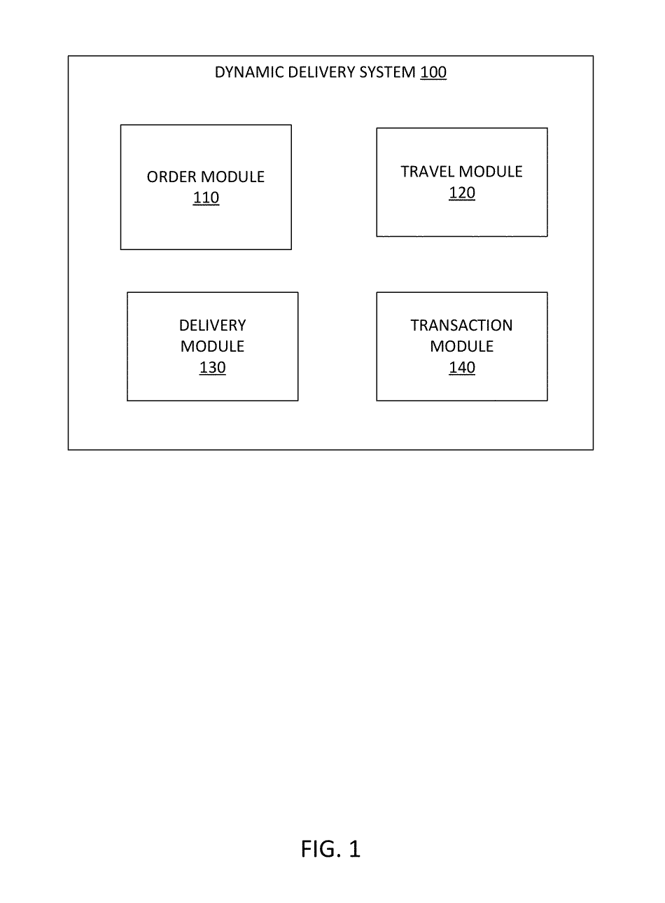

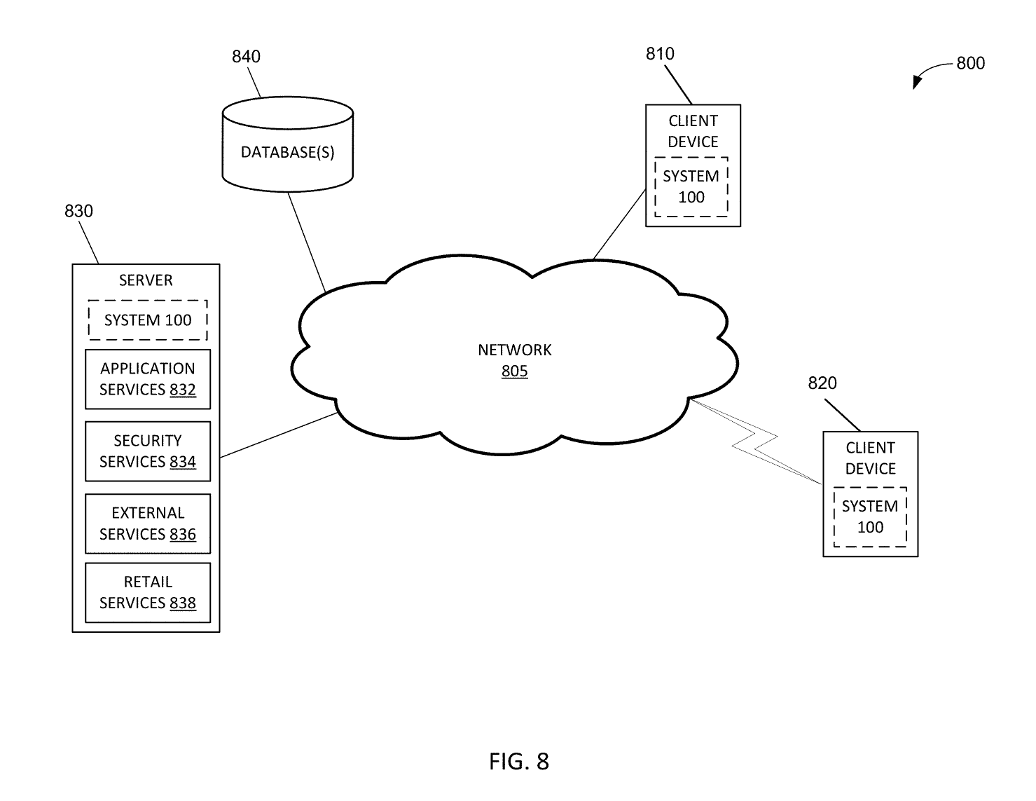

FIG. 1 is a block diagram showing a dynamic delivery system 100 in terms of modules according to an example embodiment. One or more of the modules may be implemented using server 830 shown in FIG. 8, while other modules may be implemented using client devices 810, 820 shown in FIG. 8. The modules include an order module 110, a travel module 120, a delivery module 130, and a transaction module 140. The modules may include various circuits, circuitry and one or more software components, programs, applications, or other units of code base or instructions configured to be executed by one or more processors. Although modules 110, 120, 130, and 140 are shown as distinct modules in FIG. 1, it should be understood that modules 110, 120, 130, and 140 may be implemented as fewer or more modules than illustrated. It should be understood that modules 110, 120, 130, and 140 may communicate with one or more components included in system 800 (FIG. 8), such as client devices 810, 820, server 830, and database(s) 840. One or more components and functionalities of the dynamic delivery system 100 may be provided as an application (e.g., mobile application) that the individual can download or install on the client device 810, 820.

The order module 110 may be a hardware or software-implemented module configured to manage and analyze data relating to an order, including item name, item number, pick up location, etc.

The travel module 120 may be a hardware or software-implemented module configured to manage and analyze data relating to travel plans or itinerary of an individual to facilitate dynamic delivery scheduling according to some embodiments.

The delivery module 130 may be a hardware or software-implemented module configured to manage and analyze data relating to the order and the travel plans for the individual to facilitate scheduling of delivery of the order to the individual based on his or her travel plans.

The transaction module 140 may be a hardware or software module configured to manage and facilitate purchase transactions for the order placed by the individual using the dynamic delivery system described herein.

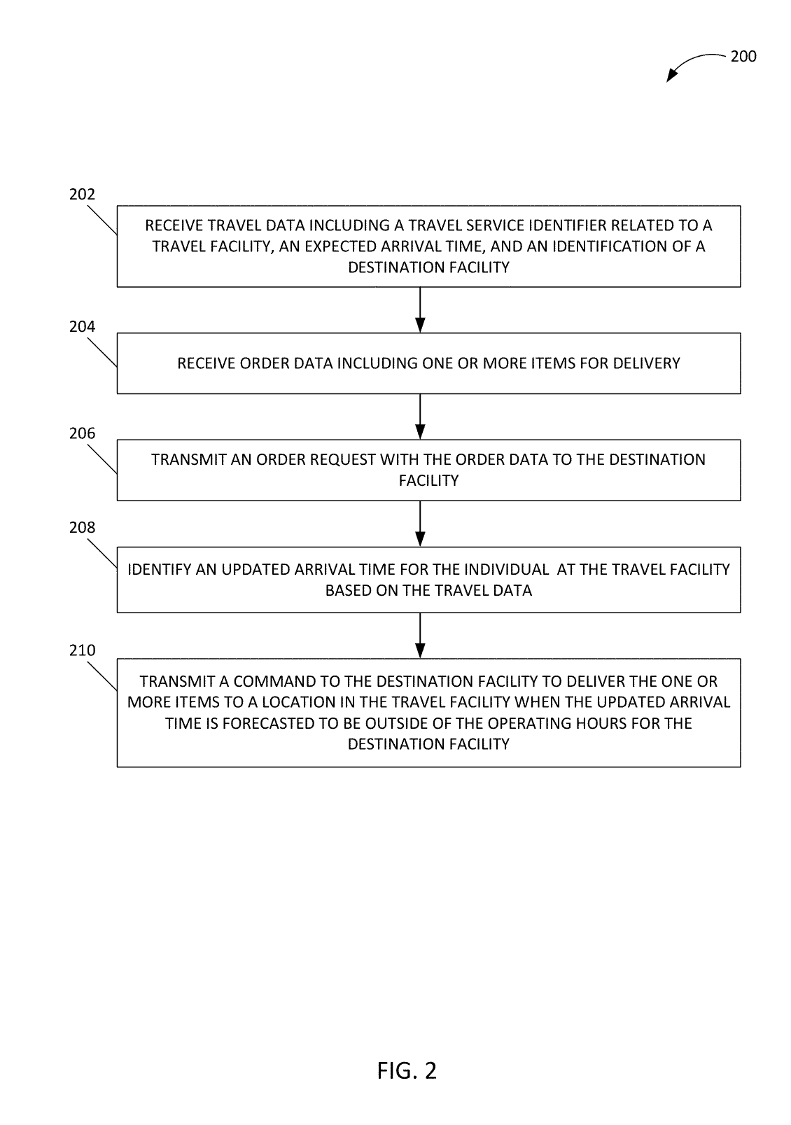

FIG. 2 is a flowchart illustrating an exemplary method 200 for dynamic delivery scheduling, according to an example embodiment. The method 200 may be performed using one or more modules of system 100 described above.

At step 202, the travel module 120 receives travel data, for example, from a individual's client device such as, but not limited to, their smartphone. The travel data includes at least a travel service identifier related to the individual's arrival at a travel facility. For example, the travel service identifier may be, but is not limited to, a flight identifier number, a train identifier number, a bus identifier number, a water transportation vehicle (boat, ferry, cruise, etc.) identifier number, or an alphanumerical or numerical identifier for another type of travel or transportation service for a person. The travel data also includes an expected arrival time for the individual at the travel facility. The travel facility may be an airport, a train station, a bus station, a ferry terminal, a cruise port, a boat terminal, or another type of location where a travel or transportation service arrives. In some embodiments, the travel module 120 automatically retrieves the expected arrival time for the individual at the travel facility from a third party database based on the travel service identifier. In one non-limiting example, a flight identifier may be used to retrieve flight data from the carrier providing the flight to the individual.

The travel data may also include identification of a destination facility providing a location at which the individual can pick up his or her order. The destination facility may be a retail store. In an example embodiment, the dynamic delivery system automatically identifies the destination facility based on the location of the travel facility. The destination facility may be identified to the individual by the dynamic delivery system 100 as being a facility near the travel facility at which the individual is arriving, or a facility near the hotel or the accommodations where the individual may be staying, or a facility that may be on a route from the travel facility to the hotel or accommodations. The travel data may also include the individual's final destination, for example, the address for the hotel or accommodations where the individual is staying, or another location where the individual's journey ends. The travel data may further include an itinerary for the individual's journey or travel including data for one or more layovers or stops while using the travel service, one or more travel service identifiers, and one or more destination facilities.

At step 204, the order module 110 receives order data, for example from the individual's client device selected through a provided user interface via a mobile application. The order data includes at least information for one or more items for delivery. The order data may also include individual or customer identifying information.

At step 206, the order module 110 transmits an order request with the order data to the destination facility (e.g., to the computing device or server associated with the destination facility) for processing. In most situations the destination facility will processes the order for pick up when the individual's client device is detected within a geo-fenced area near and/or surrounding the destination facility pick up.

At step 208, the delivery module 130 identifies an updated arrival time for the individual at the travel facility using the travel data provided by the individual. In some cases, the travel service may be delayed or may be earlier than scheduled for arrival at the travel facility. The delivery module 130 retrieves the updated arrival time using one or more third party services, including but not limited to, a travel service status website (e.g., flight status website, train status website, bus status website, etc.) and the travel facility's website (airport website, train station website, bus stations website, etc.). In an example embodiment, the updated arrival time may indicate that the travel service has been cancelled (e.g., a cancelled status), and in response the delivery module 130 is configured to transmit a cancel order request to the destination facility.

At step 210, the delivery module 130 transmits a command to the destination facility to deliver the one or more items to a location in the travel facility when the updated arrival time is forecasted to be outside of the operating hours of the destination facility. The individual's arrival time may be delayed such that he or she is unable to go to the destination facility during its operating hours to pick up the order. In that case, the dynamic delivery system 100 is configured to transmit a command to the destination facility to process the order and deliver it to a secure location at the travel facility so the individual is still able to pick up his or her order. The travel facility may include secure locations, such as lockers or kiosks, where items from an order transmitted from the destination facility can be stored for a individual to pick up.

In an example embodiment, the delivery module 130 transmits a message to the individual's client device indicating the location in the travel facility where the order is delivered. In an example embodiment, the delivery module 130 also communicates a password or passcode to the individual's client device enabling the individual access to the secure location.

In an example embodiment, the transaction module 140 is configured to calculate a total price for the order of the one or more items including sales tax based on the location of the destination facility. The transaction module 140 is configured to transmit a message with the total price to the individual's client device.

In an embodiment, one or more beacons are disposed at first locations within or near a facility to define a geo-fenced zone associated with the facility. The geo-fenced zone may be a portion of the facility that is less than the whole facility. In some embodiments, multiple geo-fenced zones are defined within the facility. In an example embodiment, a first geo-fenced zone may overlap a second geo-fenced zone. The geo-fenced zone module 110 manages and stores information relating to the location of each beacon, and the area within the facility covered by each geo-fenced zone.

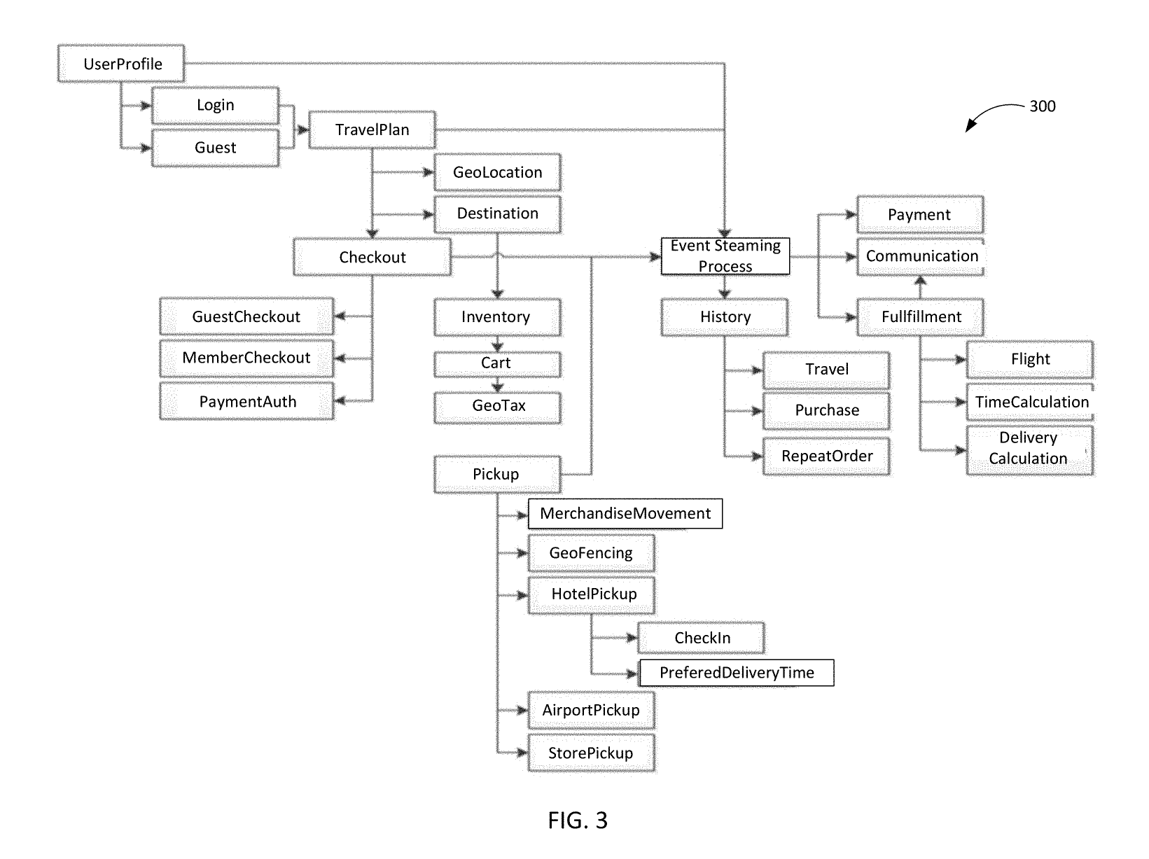

FIG. 3 is a block diagram 300 depicting exemplary software services provided by the dynamic delivery system, according to an example embodiment. The software services depicted in FIG. 3 may be implemented in software modules and/or hardware modules, and may be executed by a processor included in the client device 810, 820 or the server 830 to perform one or more functionalities of the dynamic delivery system described herein. For example, the customer's login/guest checkout services may be provided to initiate travel orders. The travel plan service may capture the customer's travel arrangement data and use it for delivery purposes. Geo location/destination services may identify and track the customer movement and calculate the approximate pickup time or delivery time. Payments may be processed through a payment authorization service. Other existing services such as inventory, cart and geo taxes may be used to identify an item's availability and to correct a payment amount to be charged to the customers. If the customer wants the order delivered, the order details may be sent to a fulfillment center. Based on the flight schedules and delays, the approximate delivery time may be calculated and the order fulfilled/delivered accordingly. It will be appreciated that additional services not specifically discussed above may also be provided within the scope of the present invention.

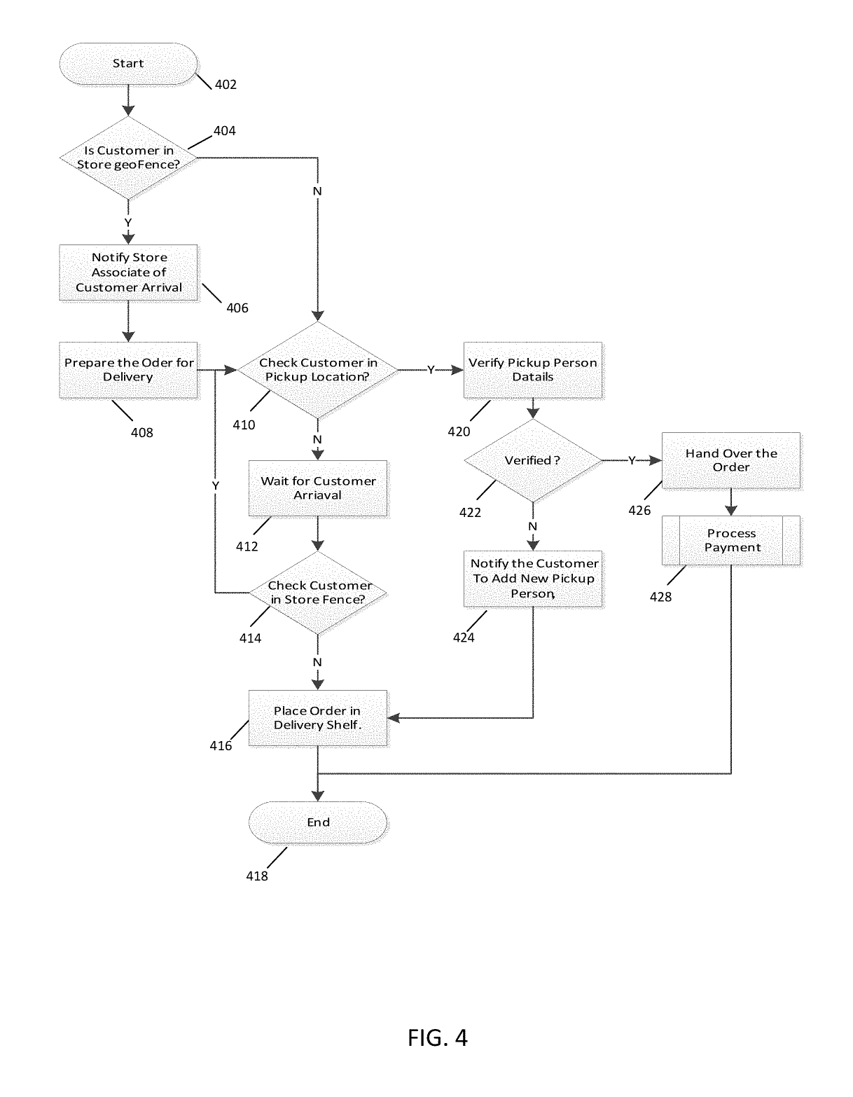

FIG. 4 is a flowchart illustrating an exemplary method 400 for the dynamic delivery system, according to example embodiments. One or more of the steps of method 400 may be performed by the client devices 810, 820 or the server 830 of FIG. 8. The method 400 may be a method for processing or fulfilling in-store pickups of orders. The method 400 starts at block 402. At block 404, the dynamic delivery system determines through the use of deployed sensors if an individual such as a customer is within a geo-fence area of a facility. If the customer is within the geo-fence area, then at block 406 the store associate is notified of the customer's arrival. The notification may be a message or an alert transmitted from the server 830 to a device associated with a store employee or the store. The store may be referred to herein as the destination facility. At block 408, the store prepares the order for delivery based on the identification of the customer within the geo-fence area. The method 400 then continues to block 410. If at block 404, it is determined that the customer is not within the geo-fence area of the store, then the method 400 continues to block 410.

At block 410, the dynamic delivery system determines if the customer checked-in at the pick up location within the store. If the customer has not checked-in at the pickup location, then at block 412 the dynamic delivery system waits for the customer's arrival. At block 414, the dynamic delivery system checks if the customer is still within the store's geo-fence area now that the order has been prepared. If the customer is within the geo-fence area, then the dynamic delivery system waits for the customer to arrive at the pick up location (block 412). If the customer is not within the store's geo-fence area, then at block 416 the order is placed on a delivery shelf, and the method ends at block 418.

At block 410, if the customer has checked-in at the pick up location within the store, then the store associate verifies the details of the customer picking up the order to ensure that the order is given to the correct person (block 420). At block 422, if the customer details are verified, then the order is provided to the customer (block 426), and payment is processed at block 428. If the customer details are not verified at block 422 (that is, the person at the pick up location does not the match the customer), then the customer is notified to add a new pick up person via the mobile application at block 424. The server 830 may transmit a message or notification to the customer's client device 810, 820 to add or authorize a new pick up person. The order is placed on the delivery shelf (block 416), and the method ends at block 418. At block 416 placing the order on the delivery shelf may refer to a store associate placing the fulfilled order in a designated area where fulfilled orders are placed for later pick up by customers.

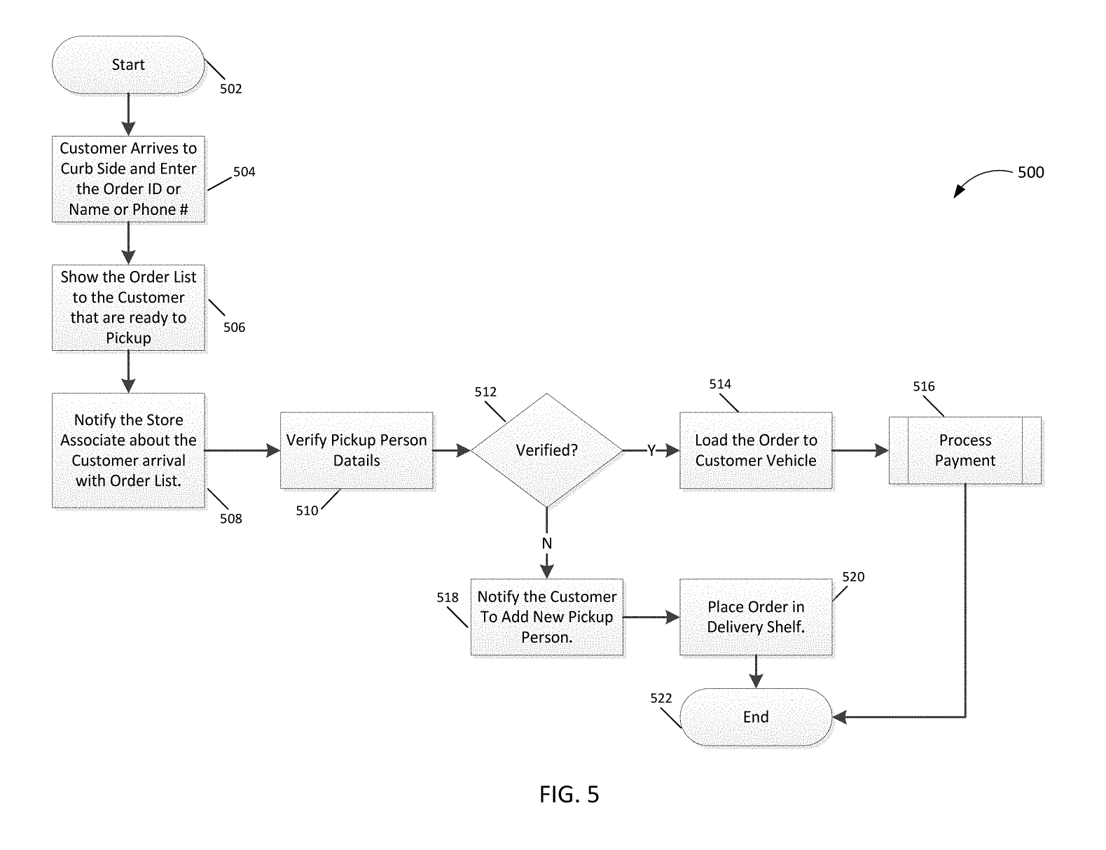

FIG. 5 is a flowchart illustrating an exemplary method 500 for the dynamic delivery system, according to example embodiments. One or more of the steps of method 500 may be performed by the client devices 810, 820 or the server 830 of FIG. 8. The method 500 may be a method for processing or fulfilling curb side pick up orders. The method 500 starts at block 502. At block 504, the individual arrives at the curb side pick up area of a store, and enters an order identifier number, a customer name, and/or a customer phone number at a user interface of a device located at the curb side pick up area.

At block 506, the user interface on the device at the curb side pick up area displays a list of orders ready for pick up at the area. In an example embodiment, the user interface only displays a list of orders associated with the data inputted at block 504. At block 508, a store associate is notified that a individual has arrived at the curb side for an order pick up. The device at the curb side pick up area may transmit a message to a device associated with the store associate, and the message may indicate the individual's name and/or identify the order for the individual.

At block 510, the store associate verifies the pick up person's details. If the details are verified, then at block 514, the store associate provides the order to the pick up person, and may load the order in the pick up person's vehicle. At block 516, payment for the order is processed, and the method ends at block 522.

If the pick up person's details are not verified (that is, the person at the pick up location does not the match the individual), then the individual is notified to add a new pick up person at block 518. The server 830 may transmit a message or notification to the mobile application executing on the individual's client device 810, 820 to add or authorize a new pick up person. The order is placed on the delivery shelf (block 520), and the method ends at block 522. At block 520 placing the order on the delivery shelf may refer to a store associate placing the fulfilled order in a designated area where fulfilled orders are placed for later pick up by individuals.

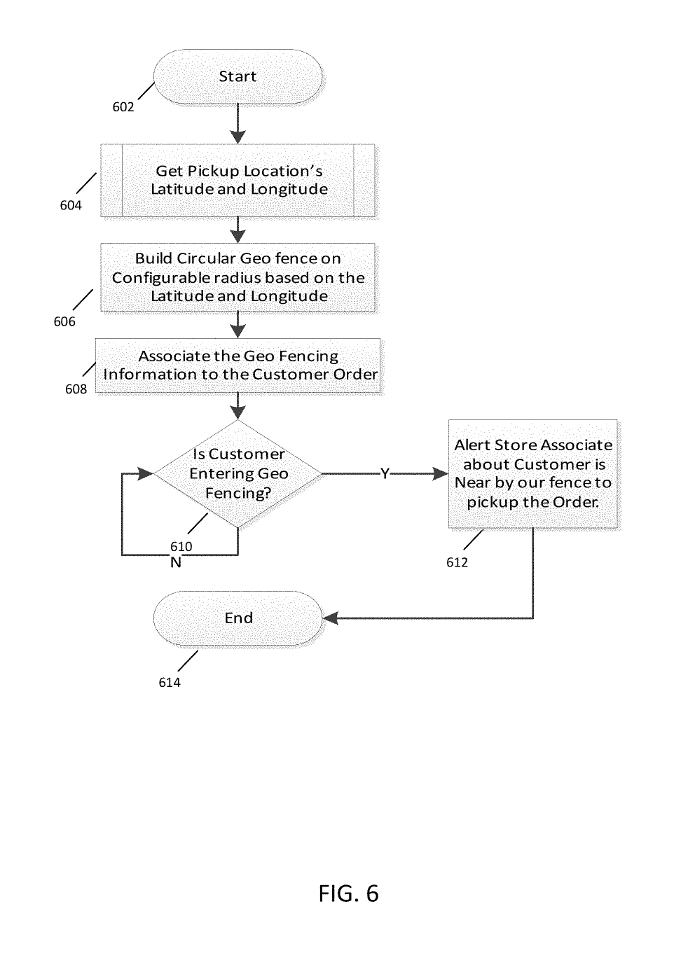

FIG. 6 is a flowchart illustrating an exemplary method 600 for the dynamic delivery system, according to example embodiments. One or more of the steps of method 600 may be performed by the server 830 of FIG. 8. The method 600 may be a method for creating a geo-fence area based on an order placed by the individual. The method 600 starts at block 602. At block 604, the dynamic delivery system retrieves the pick up location's latitude and longitude. The pick up location may be the destination location described above, or a location indicated by the individual where he or she would like to pick up the order.

At block 606, the dynamic delivery system builds a circular geo fence using a specified radius from the latitude and longitude of the pick up location. The radius may be pre-defined in the dynamic delivery system. The radius may vary by pick up location. At block 608, the geo fence information is associated to the order placed by the individual. At block 610, the dynamic delivery system determines if the individual enters the geo fence area. For example, the mobile application may send GPS coordinates that are located within the geo-fence from the individual's smartphone to the server. If the individual has entered the geo fence area, then the store associate is alerted that the individual is nearby for the order pick up (block 612).

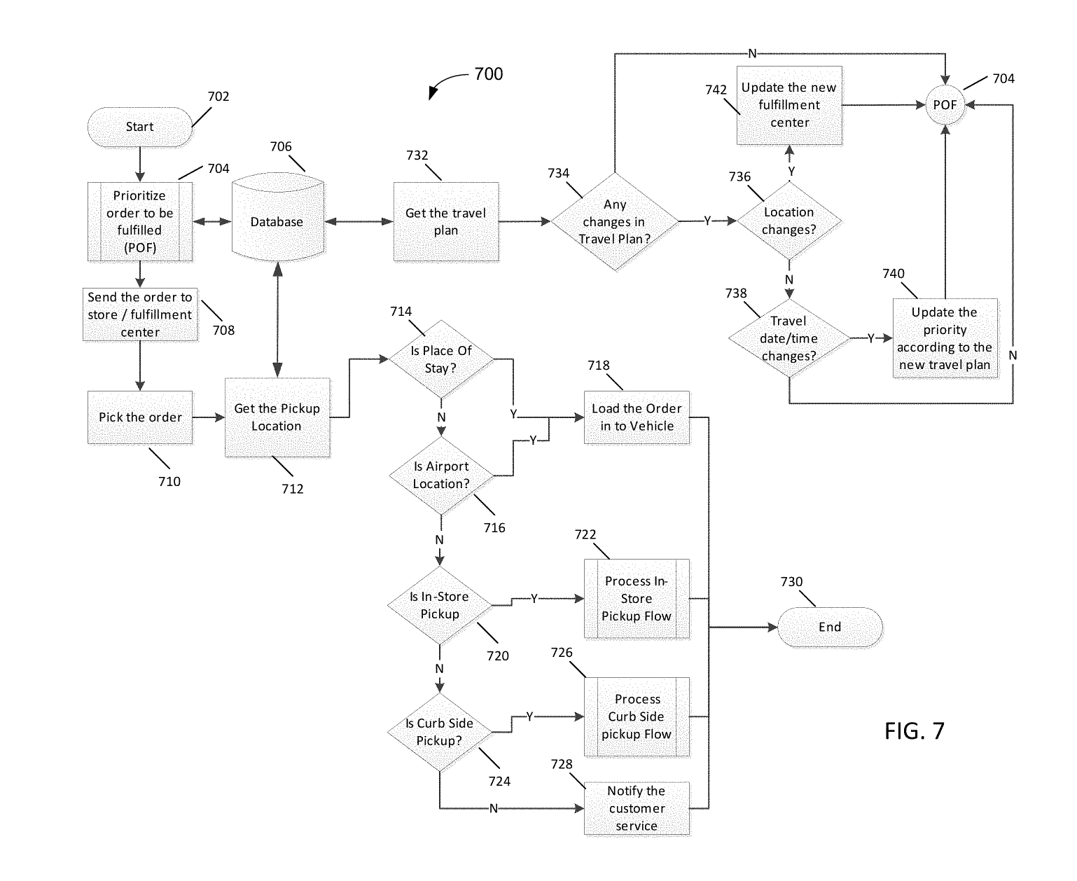

FIG. 7 is a flowchart illustrating an exemplary method 700 for the dynamic delivery system, according to example embodiments. One or more of the steps of method 700 may be performed by the client device 810, 820, or the server 830 of FIG. 8. The method 700 may be a method for scheduling delivery of an order. The method 700 starts at block 702. At block 704, the order is prioritized for fulfillment (POF). The prioritizing may be based on the customer pick up/delivery time changes, which are allowed up to x hours before a scheduled delivery, flight schedule changes and a distance between fulfillment center and delivery location. In order to prioritize the order, order data and travel data may be retrieved from database 706.

At block 708, the order is sent to the store or fulfillment center (which may be referred to herein as the destination facility). At block 710, the store or fulfillment center processes and picks the order, and prepares it for delivery. At block 712, the dynamic delivery system retrieves the pick up location from the database 706. In the next steps, the dynamic delivery system determines the type of the pick up location to choose the appropriate fulfillment process.

At block 714, the dynamic delivery system determines if the pick up location is a place at which the individual may be staying for a period of time (e.g., a hotel or a residence). If it is, then the method continues to block 718, where the order is loaded in a delivery vehicle to transport to the pick up location, and the method ends at block 730. At block 716, the dynamic delivery system determines if the pick up location is an airport, or another travel facility where the individual is expected to arrive. If it is, then the method continues to block 718, where the order is loaded in a delivery vehicle to transport to the travel facility, and the method ends at block 730.

At block 720, the dynamic delivery system determines if the pick up is an in-store pick up. If it is, then at block 722 the dynamic delivery system processes or executes the in-store pick up flow. An exemplary in-store pick up flow or method is described in relation with FIG. 4. The method then ends at block 730.

At block 724, the dynamic delivery system determines if the pick up is a curb-side pick up. If it is, then at block 726 the dynamic delivery system processes or executes the curb side pick up flow. An exemplary curb side pick up flow or method is described in relation with FIG. 5. The method then ends at block 730.

If the pick up location is not listed in connection with blocks 714, 716, 720, or 724, then at block 728 customer service is notified. The server 830 may transmit a message or notification to a device associated with the store or the fulfillment center identified at block 708 to indicate that the order may have an error and may not include a valid pick up location.

The method 700 also includes block 732, where the dynamic delivery system retrieves travel plans, data or information for the individual from the database 706. At block 734, the dynamic delivery system determines if there are any changes in the travel plans. If yes, then at block 736 the dynamic delivery system determines if the changes relate to a change in location (e.g., pick up location, final destination location, travel facility location, etc.). If the change does not relate to the location, then at block 738 the dynamic delivery system determines if the changes relate to a change in date or time of arrival. If the changes in the travel plan relate to the date or time of arrival, then at block 740 the priority for the order is updated according to the new travel plan. The method then loops back to block 704 (POF).

If the changes in the travel plan relates to a location change, then at block 742 the dynamic delivery system updates the store or fulfillment center information according to the new travel plan. The method then loops back to block 704 (POF).

If there are no changes in the travel plan (block 734), then the method 700 loops back to block 704 (POF). If the changes in the travel plan do not relate to a change in location or a change in date or time, then the method 700 loops back to block 704 (POF).

FIG. 8 illustrates a network diagram depicting a system 800 for implementing the dynamic delivery system, according to an example embodiment. The system 800 can include a network 805, multiple client devices, for example, client device 810, client device 820, a server 830, and database(s) 840. Each of the client devices 810, 820, server 830, and database(s) 840 is in communication with the network 805.

In an example embodiment, one or more portions of network 805 may be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

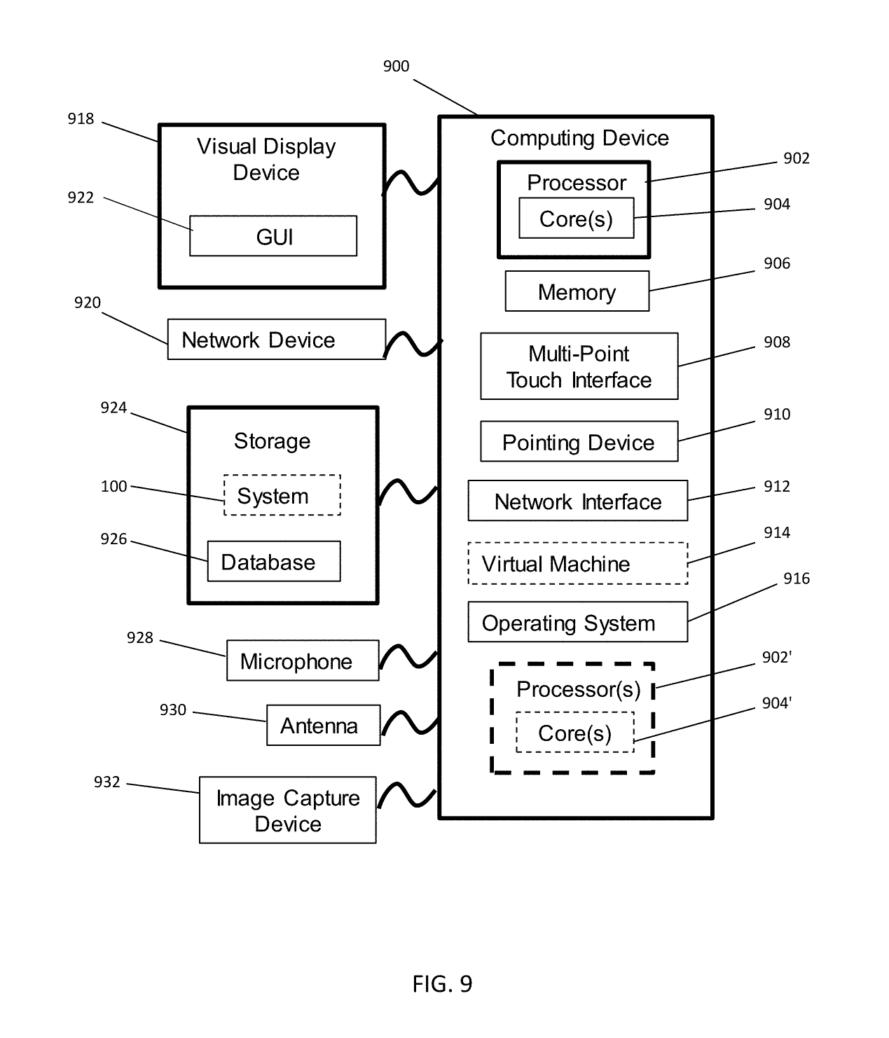

The client devices 810, 820 may comprise, but are not limited to, mobile devices, hand-held devices, wireless devices, portable devices, wearable computers, cellular or mobile phones, portable digital assistants (PDAs), smart phones, smart watches, tablets, ultrabooks, netbooks, laptops, desktops, multi-processor systems, microprocessor-based or programmable consumer electronics, and the like. Each of client devices 810, 820 may connect to network 805 via a wired or wireless connection. In an example embodiment, the client devices 810, 820 may perform one or more of the functionalities of the dynamic delivery system 100 described herein, or transmit data or signals to the dynamic delivery system 100 described herein. For example, an individual may use the client device 810, 820 to place his or her order and input data for a purchase transaction, including information or for one or more items to be delivered, payment information, and the like. The individual may also input travel data using the client device 810, 820, identifying a travel service, an expected arrival time at a travel facility, and identification of a destination facility. The client device 810, 820 can include one or more components of computing device 900 of FIG. 9. The client device 810, 820 may be carried by an individual near a destination facility, where the destination facility detects the presence of the client device 810, 820 within a geo-fenced area for the destination facility according to exemplary embodiments described herein.

In an example embodiment, the dynamic delivery system 100 may be included at least in part on the client device 810, 820, and the client device 810, 820 performs one or more of the functionalities of the system described herein. In an example embodiment, the dynamic delivery system 100 may be included at least in part on the server 830, and the server 830 performs one or more of the functionalities of the dynamic delivery system 100 described herein.

The database(s) 840 comprise one or more storage devices for storing data and/or instructions (or code) for use by the server 830 and/or the client devices 810, 820. Each of the database(s) 840 and the server 830 is connected to the network 805 via a wired connection. Alternatively, one or more of the database(s) 840 and server 830 may be connected to the network 805 via a wireless connection. The server 830 comprise one or more computers or processors configured to communicate with the client devices 810, 820 via network 805. The server 830 can include one or more components of device 900 of FIG. 9. Server 830 hosts one or more software systems, applications or websites, including one or more components of the dynamic delivery system 100 described herein and/or facilitates access to the content of database(s) 840.

In an example embodiment, the server 830 also includes various software services that facilitate the functionalities of the dynamic delivery system 100, including services such as application services 832, security services 834, external services 836, and retail services 838. The application services 832 may be configured to provide services related to market analysis, an individual's location, geo-fencing, delivery, communications (e.g., alerts, emails, receipts, etc.) and the like. The security services 834 may be configured to provide services related to authentication, authorization, secure payment and the like. The external services 836 may be configured to provide services related to an individual's travel information from third-party entities (e.g., travel booking websites), flight, bus or train information (e.g., flight status websites, bus status websites, train status websites, etc.), rental car location, local public transportation, hotel locater, and the like. The retail services 838 may be configured to provide services related to local store locator, eReceipt, savings or coupons, payment, delivery, and the like.

Database(s) 840 and server 830 may be located at one or more geographically distributed locations from each other or from client devices 810, 820. Alternatively, database(s) 840, 845 may be included within server 830.

FIG. 9 is a block diagram of an exemplary computing device 900 that can be used to perform one or more steps of the methods provided by exemplary embodiments. For example, computing device 900 may be the client device 810, 820 and the server 830 as described in FIG. 8. The computing device 900 includes one or more non-transitory computer-readable media for storing one or more computer-executable instructions or software for implementing exemplary embodiments. The non-transitory computer-readable media can include, but are not limited to, one or more types of hardware memory, non-transitory tangible media (for example, one or more magnetic storage disks, one or more optical disks, one or more USB flashdrives), and the like. For example, memory 906 included in the computing device 900 can store computer-readable and computer-executable instructions or software for implementing exemplary embodiments. The computing device 900 also includes processor 902 and associated core 904, and optionally, one or more additional processor(s) 902′ and associated core(s) 904′ (for example, in the case of computer systems having multiple processors/cores), for executing computer-readable and computer-executable instructions or software stored in the memory 906 and other programs for controlling system hardware. Processor 902 and processor(s) 902′ can each be a single core processor or multiple core (904 and 904′) processor.

Virtualization can be employed in the computing device 900 so that infrastructure and resources in the computing device can be shared dynamically. A virtual machine 914 can be provided to handle a process running on multiple processors so that the process appears to be using only one computing resource rather than multiple computing resources. Multiple virtual machines can also be used with one processor.

Memory 906 can include a computer system memory or random access memory, such as DRAM, SRAM, EDO RAM, and the like. Memory 906 can include other types of memory as well, or combinations thereof. An individual can interact with the computing device 900 through a visual display device 918, such as a touch screen display or computer monitor, which can display one or more user interfaces 919 for receiving data from the individual (e.g., order data and travel data). The visual display device 918 can also display other aspects, elements and/or information or data associated with exemplary embodiments. The computing device 900 can include other I/O devices for receiving input from a individual, for example, a keyboard or another suitable multi-point touch interface 908, a pointing device 910 (e.g., a pen, stylus, mouse, or trackpad). The keyboard 908 and the pointing device 910 can be coupled to the visual display device 918. The computing device 900 can include other suitable conventional I/O peripherals.

The computing device 900 can also include one or more storage devices 924, such as a hard-drive, CD-ROM, or other computer readable media, for storing data and computer-readable instructions and/or software, such as one or more modules of the system 100 shown in FIG. 1 that implements exemplary embodiments of the notification system as described herein, or portions thereof, which can be executed to generate user interface 919 on display 918. Exemplary storage device 924 can also store one or more databases for storing suitable information required to implement exemplary embodiments. The databases can be updated by an individual or automatically at a suitable time to add, delete or update one or more items in the databases. Exemplary storage device 924 can store one or more databases 926 for storing provisioned data, and other data/information used to implement exemplary embodiments of the systems and methods described herein.

The computing device 900 can include a network interface 912 configured to interface via one or more network devices 922 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. The network interface 912 can include a built-in network adapter, network interface card, PCMCIA network card, card bus network adapter, wireless network adapter, USB network adapter, modem or another device suitable for interfacing the computing device 900 to a type of network capable of communication and performing the operations described herein. Moreover, the computing device 900 can be a computer system, such as a workstation, desktop computer, server, laptop, handheld computer, tablet computer (e.g., the iPad® tablet computer), mobile computing or communication device (e.g., the iPhone® communication device), or other form of computing or telecommunications device that is capable of communication and that has sufficient processor power and memory capacity to perform the operations described herein.

The computing device 900 can run an operating system 916, such as versions of the Microsoft® Windows® operating systems, the different releases of the Unix and Linux operating systems, a version of the MacOS® for Macintosh computers, an embedded operating system, a real-time operating system, an open source operating system, a proprietary operating system, an operating systems for mobile computing devices, or another operating system capable of running on the computing device and performing the operations described herein. In exemplary embodiments, the operating system 916 can be run in native mode or emulated mode. In an exemplary embodiment, the operating system 916 can be run on one or more cloud machine instances.

The following description is presented to enable a person skilled in the art to create and use a computer system configuration and related method and systems for dynamic delivery scheduling. Various modifications to the example embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention may be practiced without the use of these specific details. In other instances, well-known structures and processes are shown in block diagram form in order not to obscure the description of the invention with unnecessary detail. Thus, the present disclosure is not intended to be limited to the embodiments shown, but is to be accorded the widest scope consistent with the principles and features disclosed herein.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps can be replaced with a single element, component or step. Likewise, a single element, component or step can be replaced with a plurality of elements, components or steps that serve the same purpose. Moreover, while exemplary embodiments have been shown and described with references to particular embodiments thereof, those of ordinary skill in the art will understand that various substitutions and alterations in form and detail can be made therein without departing from the scope of the invention. Further still, other aspects, functions and advantages are also within the scope of the invention.

Exemplary flowcharts are provided herein for illustrative purposes and are non-limiting examples of methods. One of ordinary skill in the art will recognize that exemplary methods can include more or fewer steps than those illustrated in the exemplary flowcharts, and that the steps in the exemplary flowcharts can be performed in a different order than the order shown in the illustrative flowcharts.

What is claimed is:

1. A system for dynamic delivery scheduling, the system comprising:
a mobile application executable on an individual's mobile device;
a destination facility with a geo-fence configured to detect the individual's mobile device; and
a computing device equipped with a processor and communicatively coupled to the mobile application and the destination facility, the computing device configured to execute a travel module, an order module and a delivery module,
wherein the travel module when executed:
receives travel data including at least a travel service identifier related to a travel facility, an expected arrival time at the travel facility, and an identification of the destination facility,
wherein the order module when executed:
receives order data including one or more items for delivery,
transmits an order request with the order data to the destination facility to be processed by the destination facility upon detection of the individual's mobile device via the geo-fence, and
wherein the delivery module when executed:
identifies an updated arrival time for the individual at the travel facility based on the travel data, and
transmits a command to the destination facility to deliver the one or more items to a location in the travel facility when the updated arrival time is forecasted to be outside of an operating hours time period for the destination facility.

2. The delivery system of claim 1, wherein the travel service identifier includes one of a flight identifier number, a train identifier number, a bus identifier number, or a water transportation vehicle identifier number.

3. The delivery system of claim 1, wherein the travel facility is one of an airport, a train station, a bus station, or a ferry terminal.

4. The delivery system of claim 1, wherein the delivery module when executed retrieves the travel data from a third party travel service database.

5. The delivery system of claim 1, wherein the updated arrival time indicates a cancelled status, and in response the delivery module is configured to transmit a cancel order request to the destination facility.

6. The delivery system of claim 1, wherein the travel data includes an itinerary including data for one or more layovers or stops, one or more travel service identifiers, and one or more destination facilities.

7. The delivery system of claim 1, wherein the delivery module when executed transmits a message to the mobile device, the message indicating the location in the travel facility where the one or more items is delivered.

8. The delivery system of claim 1, wherein the order module when executed calculates a total price for the one or more items, the total price including sales tax based on a location of the destination facility, and transmits a message with the total price to the individual's mobile device.

9. The delivery system of claim 1, wherein the destination facility is automatically identified by the computing device based on a location of the travel facility.

10. A computer-implemented method for dynamic delivery scheduling, the method comprising:
receiving travel data including at least a travel service identifier related to a travel facility, an expected arrival time at the travel facility, and an identification of a destination facility;
receiving order data including one or more items for delivery;
transmitting an order request with the order data to the destination facility, the destination facility including a geo-fence configured to detect an individual's mobile device, the order request to be processed by the destination facility upon detection of the individual's mobile device via the geo-fence;
identifying an updated arrival time for the individual at the travel facility based on the travel data;
transmitting a command to the destination facility to deliver the one or more items to a location in the travel facility when the updated arrival time is forecasted to be outside of an operating hours time period for the destination facility.

11. The method of claim 10, wherein the travel service identifier includes one of a flight identifier number, a train identifier number, a bus identifier number, or a water transportation vehicle identifier number.

12. The method of claim 10, wherein the travel facility is one of an airport, a train station, a bus station, or a ferry terminal.

13. The method of claim 10, wherein the travel data is retrieved from a third party travel service database.

14. The method of claim 10, wherein the travel data indicates a cancelled status, and the method further comprises transmitting a cancel order request to the destination facility.

15. The method of claim 10, wherein the travel data includes an itinerary including data for one or more layovers or stops, one or more travel service identifiers, and one or more destination facilities.

16. The method of claim 10, further comprising:
transmitting a message to the mobile device, the message indicating the location in the travel facility where the one or more items are delivered.

17. The method of claim 10, further comprising:
calculating a total price for the one or more items, the total price including sales tax based on a location of the destination facility; and
transmitting a message with the total price to the individual's mobile device.

18. The method of claim 10, further comprising:
automatically identifying the destination facility based on a location of the travel facility.

19. A non-transitory machine-readable medium storing instructions executable by a processing device, wherein execution of the instructions causes the processing device to implement a method for dynamic delivery scheduling, the method comprising:
receiving travel data including at least a travel service identifier related to a travel facility, an expected arrival time at the travel facility, and an identification of a destination facility;
receiving order data including one or more items for delivery;
transmitting an order request with the order data to the destination facility, the destination facility including a geo-fence configured to detect an individual's mobile device, the order request to be processed by the destination facility upon detection of the individual's mobile device via the geo-fence;
identifying an updated arrival time for the individual at the travel facility based on the travel data;
transmitting a command to the destination facility to deliver the one or more items to a location in the travel facility when the updated arrival time is forecasted to be outside of an operating hours time period for the destination facility.

20. The non-transitory machine-readable medium of claim 19, wherein the method further comprises:
calculating a total price for the one or more items, the total price including sales tax based on the destination facility, and
transmitting a message with the total price to the individual's mobile device.
